(19) United States
(12) Patent Application Publication
(10) Pub. No.: US 2026/0050448 A1
(43) Pub. Date: Feb. 19, 2026

(54) CARL AS ON-PREMISE AUTO-CONFIGURE SOFTWARE/HARDWARE APPLIANCE

(71) Applicant: Kunato Inc., New York, NY (US)

(72) Inventors: Illan POREH, New York, NY (US); MADHUSUDHANAN KRISHNAMOORTHY, Bangalore (IN); CHAIKESH CHOURAGADE, Bangalore (IN)

(21) Appl. No.: 19/299,185

(22) Filed: Aug. 13, 2025

Related U.S. Application Data
(60) Provisional application No. 63/682,373, filed on Aug. 13, 2024.
(60) Provisional application No. 63/682,381, filed on Aug. 13, 2024.

(51) Int. Cl. G06F 9/445

(52) U.S. Cl. CPC G06F 9/44505

(57) ABSTRACT

Systems and methods are provided for reinforcement learning techniques as an appliance including deploying and configuring a crawler service as a first container inside the appliance; deploying and configuring a vectorizer service as a second container inside the appliance; deploying the machine learning module as a third container inside the appliance, wherein the machine learning module includes a reinforcement learning algorithm configured to determine a set of parameters based on internet activities of a user in a plurality of categories, wherein the set of parameters are content attributes associated with one or more user resonance; learn the set of parameters to maximize the value function; synchronize one or more specific action outputs using one or more synchronization constraints; maintain coherence among similar entities, wherein the coherence is maintained by comparing a first multi-dimensional content feature vector of a first digital content to a second multi-dimensional content feature vector of a second digital content; optimize a utility function for one or more individual entities; and self-adjust the reinforcement learning algorithm, based on the environment at deployed location.

### RELATED APPLICATION DATA

This application claims priority to U.S. Provisional Application Nos. 63/682,373 and 63/682,381, filed Aug. 13, 2024, the disclosure of which is hereby incorporated by reference in its entirety.

### FIELD OF TECHNOLOGY

The present system relates to the field of machine learning, specifically focusing on reinforcement learning techniques as an appliance.

### BACKGROUND OF TECHNOLOGY

Reinforcement learning (RL) has emerged as a powerful paradigm within the field of artificial intelligence, enabling intelligent agents to learn optimal decision-making strategies through interaction with an environment. Traditional RL methods have demonstrated success in various applications, including game playing, robotics, and autonomous systems. However, challenges persist in terms of balancing the exploration-exploitation trade-off, handling high-dimensional state spaces, and achieving efficient convergence.

Existing RL techniques often face limitations when applied to complex and adaptive environments, hindering their scalability and adaptability. Furthermore, conventional algorithms may struggle with sample inefficiency and require extensive training data to achieve satisfactory performance. In light of these challenges, there is a recognized need for innovations that can enhance the robustness, speed, and applicability of reinforcement learning systems.

The present invention addresses these challenges by introducing novel methodologies and systems designed to overcome the limitations of traditional RL approaches. Through advancements in algorithmic techniques, continuous learning, self-adjusting, optimizing, model architectures, or system configurations, the invention aims to propel the field of reinforcement learning towards improved efficiency, adaptability, and real-world applicability

### SUMMARY OF DESCRIBED SUBJECT MATTER

It is an object or the present disclosure to provide an adaptive reinforcement learning system and method as an appliance. The disclosed adaptive reinforcement learning system as an appliance may be accessed by one or more users by means or a web or mobile application running on one or more computing devices or the one or more users over a communication network. The disclosed adaptive reinforcement learning system as an appliance may be utilized by the one or more users to perform one or more keywords-based searching for retrieving one or more digital content items from the World Wide Web or one or more databases in real time.

One compelling use case for selling Complex Adaptive Reinforcement Learning (CARL) as a software appliance is its ability to provide organizations with a powerful and flexible solution for implementing complex adaptive reinforcement learning (CARL) in their existing infrastructure. By packaging CARL as a software appliance, organizations can easily deploy and integrate this cutting-edge technology into their environment without the need for extensive development or customization.

Deploying Complex Adaptive Reinforcement Learning (CARL) as an on-premises appliance involves providing organizations with a dedicated hardware device equipped or containers/virtual machines with CARL algorithms and software capabilities. This appliance serves as a self-contained solution for implementing CARL-based AI systems within an organization's infrastructure without relying on external cloud services.

Creating capacity planning models to predict future resource requirements and utilization trends within the on-premise infrastructure are disclosed. Employ time series analysis or regression techniques to forecast resource demand based on historical usage data. Train the machine learning models using labeled or unlabeled data from the on-premise infrastructure.

In an aspect of the invention, a method is disclosed including receiving a request to deploy a machine learning module as an appliance; deploying and configuring a crawler service as a first container inside the appliance; deploying and configuring a vectorizer service as a second container inside the appliance; deploying the machine learning module as a third container inside the appliance, wherein the machine learning module includes a reinforcement learning algorithm configured to: determine a set of parameters based on internet activities of a user in a plurality of categories, wherein the set of parameters are content attributes associated with one or more user resonance; learn the set of parameters to maximize the value function; synchronize one or more specific action outputs using one or more synchronization constraints; maintain coherence among similar entities, wherein the coherence is maintained by comparing a first multi-dimensional content feature vector of a first digital content to a second multi-dimensional content feature vector of a second digital content; optimize a utility function for one or more individual entities; and self-adjust the reinforcement learning algorithm, based on the environment at deployed location.

In some embodiments, the vectorizer service dynamically chooses, filters, and aligns embeddings based on multi-layer user-context resonance scoring.

In some embodiments, determining a set of parameters includes determining one or more of the following parameters are learned from internet activity signals: rate of decay of user interest in a topic, entropy-based measurement of user consistency across content types; dwell time, scroll depth, and navigation patterns of users; logistic regression trained on user sharing vs. content rating behavior; and content diversity consumption.

In some embodiments, the method further includes periodically updating the parameters.

In some embodiments, learning the set of parameters to maximize the value function includes choosing pricing actions to maximize engagement revenue over time.

In some embodiments, synchronizing one or more specific action outputs using one or more synchronization constraints includes orchestrating multi-modal content actions.

In some embodiments, optimizing a utility function for one or more individual entities includes using a multi-objective RL controller with weighted rewards.

In some embodiments, self-adjusting the reinforcement learning algorithm based on the environment at deployed location includes detecting a breach in a threshold of one or more of bandwidth, CPU/GPU availability and KL divergence in user behavior.

In some embodiments, a self-adaptive controller triggers a policy change in the case of a threshold breach.

In some embodiments, the appliance is deployed as an on-premise multi-container appliance.

In some embodiments, the deployment of the on-premise multi-container appliance is orchestrated from the cloud.

In some embodiments, the method further includes the machine learning module as a third container inside the appliance learning the environment at deployed location.

In some embodiments, the method further includes, upon deploying and configuring the crawler service as the first container inside the appliance, verifying, by the processor, the deployment and configuration of the crawler service is successful.

In some embodiments, the method further includes, upon deploying and configuring the vectorizer service as the second container inside the appliance, verifying, by the processor, the deployment and configuration of the vectorizer service is successful.

In another aspect of the invention, a system is provided including a processor configured to receive, via the processor, a request to deploy a machine learning module as an appliance; deploy and configure, by the processor, a crawler service as a first container inside the appliance; upon deploying and configuring, verify, by the processor, the deployment and configuration of the crawler service is successful, deploy and configure, by the processor, a vectorizer service as a second container inside the appliance; upon deploying and configuring, verify, by the processor, the deployment and configuration of the vectorizer service is successful; and deploy, by the processor, the machine learning module as a third container inside the appliance, wherein the machine learning module includes a reinforcement learning algorithm configured to determine, by the processor, a set of parameters based on internet activities of a user in the plurality of categories, wherein the set of parameters are the content attributes associated with one or more user resonance; learn, by the processor, the set of parameters to maximize the value function; synchronize, by the processor, one or more specific action outputs using one or more synchronization constraints; maintain, by the processor, coherence among similar entities, wherein the coherence is maintained by comparing a first multi-dimensional content feature vector of a first digital content to a second multi-dimensional content feature vector of a second digital content; optimize, by the processor, a utility function for one or more individual entities; and self-adjust, by the processor, the reinforcement learning algorithm, based on the environment at deployed location.

In some embodiments, the vectorizer service is configured to dynamically choose, filter, and align embeddings based on multi-layer user-context resonance scoring.

In some embodiments, the machine learning module is configured to learn one or more of the following parameters from internet activity signals: rate of decay of user interest in a topic, entropy-based measurement of user consistency across content types; dwell time, scroll depth, and navigation patterns of users; logistic regression trained on user sharing vs. content rating behavior; and content diversity consumption.

In some embodiments, the machine learning module is configured to periodically updating the parameters.

In some embodiments, the system further includes a processor configured to learn the set of parameters to maximize the value function includes choosing pricing actions to maximize engagement revenue over time.

In some embodiments, the system further includes a processor configured to synchronize one or more specific action outputs using one or more synchronization constraints includes orchestrating multi-modal content actions.

In some embodiments, the system further includes a processor configured to optimize a utility function for one or more individual entities includes using a multi-objective RL controller with weighted rewards.

In some embodiments, the system further includes a processor configured to self-adjust the reinforcement learning algorithm based on the environment at deployed location includes detecting a breach in a threshold of one or more of bandwidth, CPU/GPU availability and KL divergence in user behavior.

In some embodiments, the system further includes a self-adaptive controller triggers a policy change in the case of a threshold breach.

In some embodiments, the system further includes the appliance is deployed as an on-premise multi-container appliance.

In some embodiments, the system further includes the deployment of the on-premise multi-container appliance is orchestrated from the cloud.

In some embodiments, the system further includes the machine learning module as a third container inside the appliance learning the environment at deployed location.

In a further aspect of the invention, one or more non-transitory computer readable media having instructions stored thereon is provided, the instructions executable by a processor to cause the processor to receive, via the processor, a request to deploy a machine learning module as an appliance; deploy and configure, by the processor, a crawler service as a first container inside the appliance; upon deploying and configuring, verify, by the processor, the deployment and configuration of the crawler service is successful; deploy and configure, by the processor, a vectorizer service as a second container inside the appliance; upon deploying and configuring, verify, by the processor, the deployment and configuration of the vectorizer service is successful; and deploy, by the processor, the machine learning module as a third container inside the appliance, wherein the machine learning module includes a reinforcement learning algorithm configured to determine, by the processor, a set of parameters based on internet activities of a user in the plurality of categories, wherein the set of parameters are the content attributes associated with one or more user resonance; learn, by the processor, the set of parameters to maximize the value function; synchronize, by the processor, one or more specific action outputs using one or more synchronization constraints; maintain, by the processor, coherence among similar entities, wherein the coherence is maintained by comparing a first multi-dimensional content feature vector of a first digital content to a second multi-dimensional content feature vector of a second digital content; optimize, by the processor, a utility function for one or more individual entities; and self-adjust, by the processor, the reinforcement learning algorithm, based on the environment at deployed location.

In some embodiments, the vectorizer service is configured to dynamically choose, filter, and align embeddings based on multi-layer user-context resonance scoring.

In some embodiments, the machine learning module is configured to learn one or more of the following parameters from internet activity signals: rate of decay of user interest in a topic, entropy-based measurement of user consistency across content types; dwell time, scroll depth, and navigation patterns of users; logistic regression trained on user sharing vs. content rating behavior; and content diversity consumption.

In some embodiments, the machine learning module is configured to periodically update the parameters.

In some embodiments, the one or more non-transitory computer readable media further includes to instructions to learn the set of parameters to maximize the value function includes choosing pricing actions to maximize engagement revenue over time.

In some embodiments, the one or more non-transitory computer readable media further includes to instructions to synchronize one or more specific action outputs using one or more synchronization constraints includes orchestrating multi-modal content actions.

In some embodiments, the one or more non-transitory computer readable media further includes to instructions to optimize a utility function for one or more individual entities includes using a multi-objective RL controller with weighted rewards.

In some embodiments, the one or more non-transitory computer readable media further includes to instructions to self-adjust the reinforcement learning algorithm based on the environment at deployed location includes detecting a breach in a threshold of one or more of bandwidth, CPU/GPU availability and KL divergence in user behavior.

In some embodiments, the one or more non-transitory computer readable media further includes to instructions for a self-adaptive controller triggers a policy change in the case of a threshold breach.

In some embodiments, the one or more non-transitory computer readable media further includes to instructions for the appliance to be deployed as an on-premise multi-container appliance.

In some embodiments, the one or more non-transitory computer readable media further includes to instructions for the deployment of the on-premise multi-container appliance is orchestrated from the cloud.

In some embodiments, the one or more non-transitory computer readable media further includes to instructions for the machine learning module as a third container inside the appliance learning the environment at deployed location.

In an embodiment of the invention, a method and system is described with the steps of receiving a request to deploy a machine learning module as an appliance, deploying and configuring a crawler service as a first container inside the appliance, upon deploying and configuring, verifying the deployment and configuration of the crawler service is successful, deploying and configuring a vectorizer as a second container inside the appliance, upon deploying and configuring, verifying the deployment and configuration of the vectorizer service is successful, and deploying the machine learning module as a third container inside the appliance, wherein the machine learning module is configured to: determining set of parameters based on internet activities of a user in the plurality of categories, wherein the set of parameters are the content attributes associated with one or more user resonance and overall value ecosystem of a digital content economy, learning the set of parameters to maximize the value function, synchronizing one or more specific action outputs using one or more synchronization constraints, maintaining coherence among similar entities, wherein the coherence is maintained by comparing a first content genome of a first digital content to a second content genome of a second digital content, optimizing a utility function for one or more individual entities, and self-adjusting, the reinforcement learning algorithm, based on the environment at deployed location.

In another embodiment of the invention, forecasting the resource utilization of the appliance using capacity planning models.

In another embodiment of the invention, deploying the machine learning module as the third container inside the appliance performing the capacity planning models.

In another embodiment of the invention, a management software module performing the step of deploying the machine learning module as a third container inside the appliance.

In another embodiment of the invention, the appliance is deployed as an on-premise multi-container appliance.

In another embodiment of the invention, the deployment of the on-premise multi-container appliance is orchestrated from the cloud.

In another embodiment of the invention, deploying the machine learning module as a third container inside the appliance learning the environment at deployed location.

In an embodiment of the invention, the CARL as an appliance for deploying applications comprises a pre-configured software stack bundled with an operating system optimized for a specific purpose. The software appliance includes a virtual machine image or containerized application that can be deployed on various virtualization platforms or cloud environments. The appliance is designed for case of installation and configuration, providing a turnkey solution for deploying complex software applications without the need for manual setup. The software appliance encapsulates all dependencies, libraries, and configuration settings required to run the application, ensuring consistent behavior across different environments. Users can deploy the software appliance by importing the virtual machine image or container and configuring minimal settings, thereby simplifying the deployment process and reducing overhead associated with traditional software installations.

In another embodiment of the invention, CARL as a hardware appliance comprises a dedicated physical device designed to perform specific functions or tasks, typically without the need for user installation or configuration. The hardware appliance includes integrated hardware components such as processors, memory, storage, and network interfaces, all optimized for the intended purpose. The appliance is pre-installed with firmware or software that enables it to operate autonomously upon power-up. Hardware appliances are commonly used for networking, security, storage, and other specialized applications where dedicated hardware resources provide performance advantages over software-based solutions. The design of a hardware appliance can vary from compact single-purpose devices to modular systems that can scale with additional components or configurations. By providing a self-contained and purpose-built solution, hardware appliances offer simplicity, reliability, and predictable performance in various application scenarios.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 illustrates the system in an on-premise environment with deployment management on-premise.

FIG. 2 illustrates the system in an on-premise environment with deployment management off-premise.

FIG. 3 is a flowchart of a process in accordance with exemplary embodiments of the disclosed subject matter.

FIG. 4 illustrates a schematic view of a component of the system in accordance with exemplary embodiments of the disclosed subject matter.

FIG. 5 illustrates a schematic view of the system in accordance with exemplary embodiments of the disclosed subject matter.

While the present disclosure will be described in connection with the preferred embodiments shown herein, it will be understood that it is not intended to limit the invention to those embodiments. On the contrary, it is intended to cover all alternatives, modifications, and equivalents, as may be included within the spirit and scope of the invention as defined by the appended claims.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

The terms “include,” “have,” and variations thereof, as used herein, have the same meaning as the term “comprise” or appropriate variation thereof. Furthermore, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

The inventors are also aware of the normal precepts of English grammar. Thus, if a noun, term, or phrase is intended to be further characterized, specified, or narrowed in some way, such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

In accordance with exemplary embodiments, the CARL appliance integrates powerful hardware components, such as processors, memory, and storage, optimized for running complex machine learning algorithms and handling large-scale data processing tasks. It also includes pre-installed CARL software libraries and frameworks tailored for reinforcement learning, adaptive scaling, and autonomous decision-making. Organizations can customize and integrate the CARL appliance with existing infrastructure and applications, tailoring it to their specific use cases and requirements.

Deploying CARL as an on-premises appliance provides organizations with greater control, flexibility, and security over their AI systems while leveraging the advanced capabilities of complex adaptive reinforcement learning to drive innovation and efficiency within their operations. Deploying Complex Adaptive Reinforcement Learning (CARL) as a container appliance involves encapsulating the CARL algorithms and software capabilities within a containerized environment. This container appliance can be deployed on any infrastructure that supports containerization, such as Kubernetes clusters or Docker environments, providing organizations with a flexible and scalable solution for implementing CARL-based AI systems.

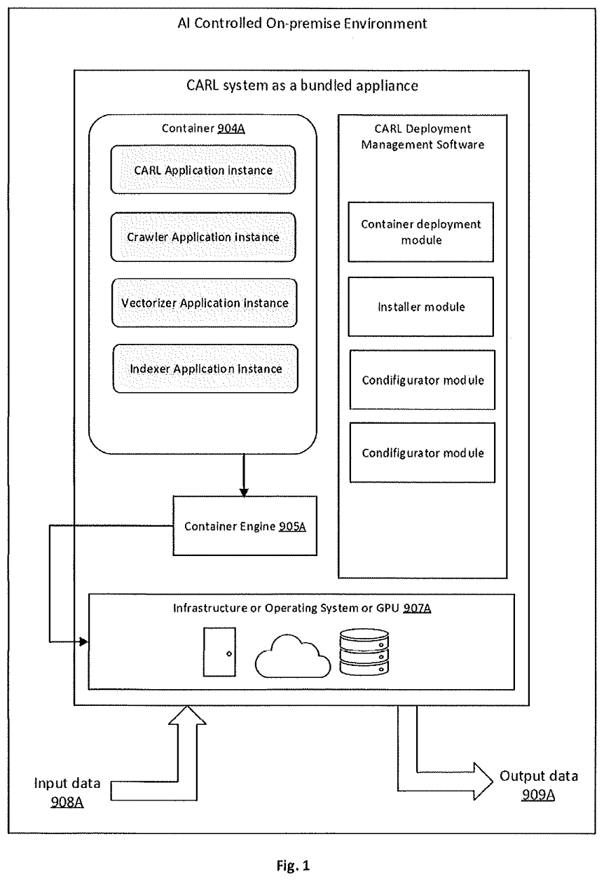

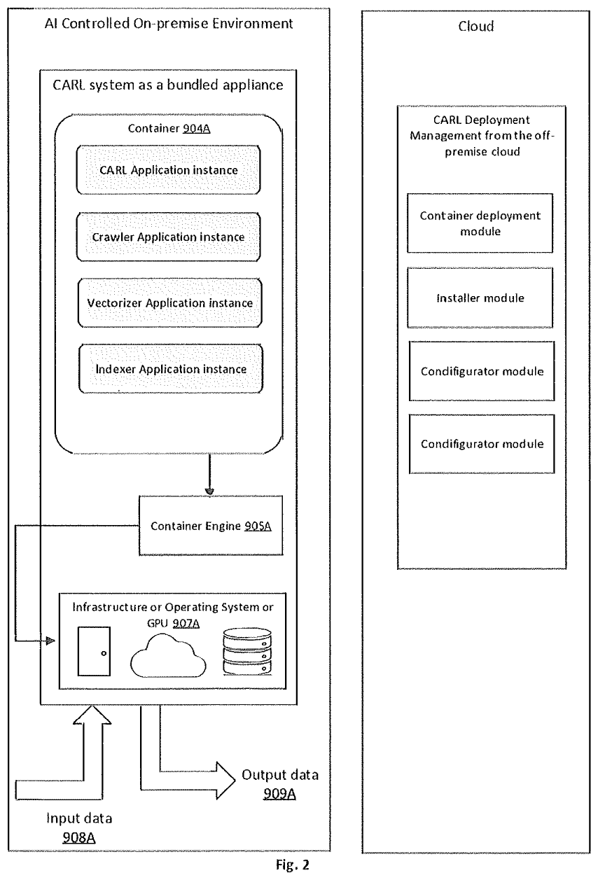

The architecture of the CARL appliance is shown in FIGS. 1-2. The CARL appliance is a bundled container appliance, such that CARL is deployed in a containerized form, including crawler, vectorizer, indexer, and RL engine. This configuration ensures seamless plug-and-play setup on any GPU, edge node, or private server. The CARL appliance configuration is “On-Premise Ready,” e.g., compatible with local hardware, hybrid clouds, or AI cores. Accordingly, it supports sectors with data sensitivity, e.g., healthcare or defense. The CARL appliance includes auto-deployment modules, e.g., built-in installer and configurator modules that automate setup. This Minimizes devops burden; zero touch configuration. The CARL appliance module includes an adaptive policy coherence engine that maintains consistency across similar entities using reinforcement signals. This configuration prevents policy drift across similar content or entities. The CARL appliance is a Synchronized Multi-Entity RL that ensures that similar inputs produce harmonized outputs. This configuration avoids contradictions, unlike standard RL models. The CARL appliance model includes Utility Function Optimization, such that custom utility functions can be defined-revenue, attention, latency. This configuration offers business-aligned optimization versus generic RL. CARL provides Cross-domain Generalizability, e.g., it can handle SKUs, articles, ads, user intents, etc., unlike RL systems that are domain-constrained. In addition to being a container of microservices, CARL is a self-learning, policy-adaptive unit that continuously optimizes outcomes in real-time, unlike rule-based or static pipelines.

At power-on, the following steps are typically performed to initialize and configure the Complex Adaptive Reinforcement Learning (CARL) container appliance. Although the steps are presented in a sequence, it is not required that the steps are performed in the ordered listed, unless one step requires completion of actions be performed before such step can begin. One step is the boot sequence: The host system powering the CARL container appliance undergoes its standard boot sequence, including BIOS/UEFI initialization, hardware detection, and bootloader execution. Another step is the operating system initialization: Once the bootloader loads the operating system, the host system's operating system (e.g., Linux) initializes, mounts filesystems, and starts essential services. A subsequent step is the container runtime startup: The container runtime engine (e.g., Docker, containerd) initializes and starts, enabling the execution of containerized applications. A next step is the CARL Container Deployment: The CARL container appliance's container image is pulled from the container registry or local repository onto the host system.

Another step in the process is Container Networking Configuration. Network interfaces and connectivity settings for the CARL container appliance are configured, allowing communication between CARL containers, external services, and users. A further step is resource allocation: Resources such as CPU cores, memory, and storage are allocated to the CARL containers based on predefined resource limits and requirements. As a still further step, initialization scripts or entry point commands are defined within the CARL container image are executed, performing any necessary setup tasks, environment configurations, or service startup procedures. Another step is service activation: The CARL container services are activated within their respective containers, initiating the CARL algorithms, libraries, and frameworks. Yet another step is the performance of health checks: Health checks may be performed to ensure the proper functioning of the CARL container appliance and its components. Any issues detected during the health checks are logged or reported for further investigation. A further step is monitoring and management: Monitoring tools or management agents may be activated to monitor the performance, resource utilization, and status of the CARL container appliance. Administrators can use these tools to troubleshoot issues, optimize performance, and manage the CARL environment. By following these steps at power-on, the CARL container appliance can be initialized, configured, and made ready for use, enabling organizations to leverage the power of adaptive reinforcement learning in their AI applications.

In contrast to existing models, such as a Large Language Model (LLM), which operate with static databases, the CARL function in a real-time, dynamic, and intricately complex ecosystem, managing an ever-changing and vast fluid dataset. Every second, it seamlessly processes interactions from millions of users, accurately recalibrating the values and prices of numerous content items in real-time. This capability to process, scale, maintain credibility, and ensure equitability and fairness represents a groundbreaking advancement in AI science. Such a model holds the potential for adaptation across various sectors and solutions, particularly in addressing complex, dynamic, and real-time adaptive scenarios.

This comparison forms part of a real-time recursive model utilizing Adaptive Reinforcement Learning, ensuring market equilibrium and fairness. Therefore, even if individual content weights are adjusted, the overall impact on the pricing system is minimized. It's worth noting that Deep RL systems are not typically designed for real-time adaptation in rapidly changing environments. While they can make decisions in real time, their underlying policy does not adapt in real time to changing circumstances or events.

The invention introduces a unique feature called “one thing influencing many events simultaneously”, wherein a singular factor has the capability to influence numerous events simultaneously. Unlike conventional systems where individual parameters are adjusted independently, this innovation incorporates a holistic approach, allowing a single element to exert a cascading effect across multiple events concurrently. This synchronized influence enhances the efficiency and coherence of the system, enabling a unified response to various interconnected aspects. In the context of Real-Time AI, this means that a single influential factor can dynamically impact numerous aspects of the system concurrently, providing a more comprehensive and streamlined approach to decision-making in complex, interconnected scenarios. This novel capability represents a significant advancement in the field, offering a more integrated and efficient solution for handling real-time, multifaceted data interactions.

The invention introduces a unconventional concept characterized by the generation of massive ripple effects within the system. Unlike traditional models where adjustments to individual components have localized impacts, this innovation triggers expansive and interconnected consequences across the entire system. In the context of Real-Time AI, a small modification or input can lead to cascading effects, influencing a multitude of events on a grand scale. This dynamic ripple effect ensures that changes propagate swiftly and comprehensively throughout the system, creating a highly responsive and adaptive environment. This novel feature enhances the system's ability to handle intricate, real-time scenarios by enabling the simultaneous consideration of numerous interrelated factors, leading to a more synchronized and efficient decision-making process.

The system uses machine learning to identify the on-premise infrastructure. The system creates capacity planning models to predict future resource requirements and utilization trends within the on-premise infrastructure; employs time series analysis or regression techniques to forecast resource demand based on historical usage data; and trains the machine learning models using labeled or unlabeled data from the on-premise infrastructure.

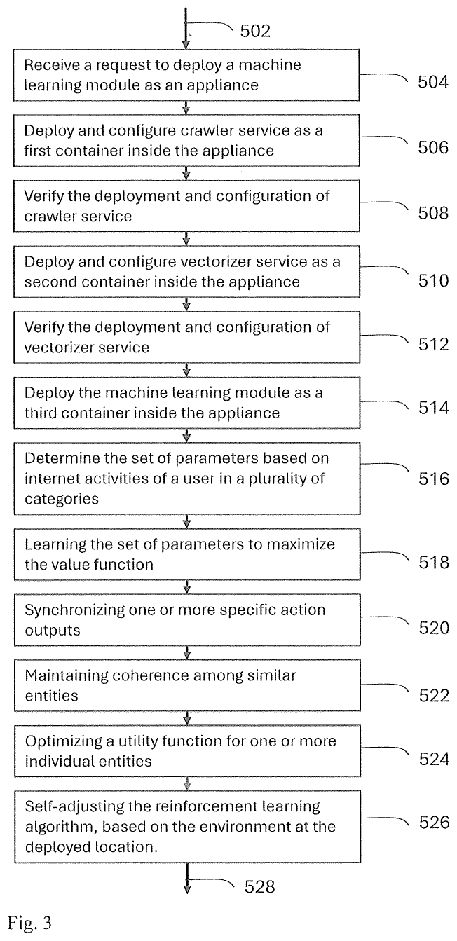

As illustrated in FIG. 3, in connection with FIGS. 1 and 2, exemplary embodiments perform the process flow 500, beginning at step 502. At step 504, a request is received to deploy a machine learning module as an appliance. At step 506, a crawler service is deployed and configured as a first container inside the appliance. Upon deploying and configuring, verification of the deployment and configuration of the crawler service is performed (Step 508).

At step 510, a vectorizer service is deployed and configured as a second container inside the appliance. The vectorizer is a containerized, low-latency adaptive embedding engine that dynamically selects one of several transformer architectures based on content type. In an exemplary embodiment for, it uses DistilBERT with a custom fine-tuned layer on resonance prediction labels for text articles. For social metadata, it uses MPNet+intent filters to encode multi-turn engagement context. For non-English content, it relies on LaBSE or XLM-R with a locality-adaptive normalization layer. The vectorizer includes a Resonance Post-Filter Module that evaluates embeddings using a scoring model trained on 2 million user-content interactions to refine outputs based on predictive alignment with user satisfaction. The model dynamically chooses, filters, and aligns embeddings based on multi-layer user-context resonance scoring, which is not found in general vectorization pipelines. Upon deploying and configuring, verification of the deployment and configuration of the vectorizer service is performed (Step 512).

An indexing function is distributed across two core components, e.g., within the crawler container and the vectorizer container. As the crawler collects digital content and associated user activity (user logs, content metadata), it simultaneously labels and groups content into indexed topic categories using one or more of NLP-based entity linking (e.g., linking content to topics like “climate change” or “AI policy”) and temporal segmentation (e.g., indexing by activity time and user burst patterns). After embedding, the vector representations are stored with content and user identifiers, forming a vector index searchable by similarity. This includes FAISS or ScaNN-based vector index generation and annotations attached to vectors for auditability (timestamp, user segment). Indexing is thus performed in the crawler through symbolic and keyword-based indexing and in the vectorizer through semantic vector indexing

At step 514, a machine learning module is deployed and configured as a third container inside the appliance. At step 516, the machine learning (ML) module is configured to determine set of parameters based on internet activities of a user in the plurality of categories. In some embodiments, this includes deriving weights or configurations based on input data and history. e.g., determining optimal display time for content based on previous click through rates (CTRs). The set of parameters are the content attributes associated with one or more user resonance and overall value ecosystem of a digital content economy. The step is performed, e.g., by the CARL Application instance, illustrated in Container 904A (See FIGS. 1-2.) The core RL unit determines reward functions, policy parameters, and learning rates based on current state, environment feedback, and metadata inputs.

In an exemplary embodiment, upon deployment, the ML module generates the following categories of parameters, each learned from distinct internet activity signals:
recency_curve: how fast user interest in a topic decays (modelled using exponential decay functions on click timestamps)
category_stability_index: entropy-based measurement of user consistency across content types
engagement_intent: derived from dwell time, scroll depth, and navigation pattern (classified using gradient-boosted trees)
trust_score: logistic regression trained on user sharing vs. content rating behaviour
user_value_entropy: content diversity consumption normalized using Kullback-Leibler divergence

These parameters are stored as a user-content matrix in the appliance and updated through rolling windows every 24 hours.

At step 518, the machine learning module learns the set of parameters to maximize the value function. This step uses RL to learn a policy that maximizes cumulative reward, e.g., choosing pricing actions that maximize engagement revenue over time. The function of maximizing the value function is performed by the CARL application instance and an optimizer module in the CARL application. The application learns a policy π that maximizes expected cumulative reward over time; employs reward shaping and dynamic objective updates. In an exemplary embodiment, DDPG (Deep Deterministic Policy Gradient) is used with two architectural enhancements: Noise-injected exploration policy via Ornstein-Uhlenbeck process for smoother continuous control, and a soft update of target networks to stabilize training over volatile behavioral logs. Additionally, for discrete state clusters, Proximal Policy Optimization (PPO) is used where action space maps to behavioral nudges (e.g., recommend, suppress, personalize). Learning is edge-adaptive, e.g., model weights are synced with a central model only when KL divergence between local and global models exceeds a defined threshold.

At step 520, the machine learning module synchronizes one or more specific action outputs using one or more synchronization constraints. This refers to aligning decisions for similar inputs, e.g., similar articles getting consistent paywall treatments. In accordance with exemplary embodiments, synchronization refers to real-time orchestration of multi-modal content actions, not just time alignment. It is executed via a constraint-checking middleware, e.g., synchronizer module (logical unit within CARL) that aligns or harmonizes actions across similar content/entities, and ensures temporal, semantic, or contextual coherence. In an exemplary embodiment, constraints include a (1) latency_window in which actions must execute within a tolerance band across containers (e.g., 150 ms); (2) behavioral state alignment, e.g., if one module detects “exploratory” mode, all others switch to low-repetition content suggestions, and (3) device-aware delivery, in which sync rules vary if user is on mobile vs. desktop (e.g., image-heavy outputs are deprioritized on mobile). In practice, each action-producing module writes to a shared temporal buffer tagged with a synchronization key. Only when all keys resolve within the window does the action chain execute.

At step 522, the machine learning module maintains coherence among similar entities, e.g., policy coordination across clusters, wherein the coherence is maintained by comparing a first content genome of a first digital content to a second content genome of a second digital content, e.g., political news and related opinion articles are treated similarly. In accordance with an exemplary embodiment, coherence is semantic, not temporal. Each digital content object is encoded into a content genome, e.g., a multi-dimensional feature vector (˜1024 dims) including one or more of an entity set; sentiment polarity; actual density; narrative arc length; and source credibility score. These are compared via cosine similarity and Jaccard topic overlap to ensure non-redundancy (e.g., two similar articles aren't shown back-to-back) and non-contradiction (e.g., contradictory headlines not delivered in the same session). This coherence layer works downstream of synchronization and enforces semantic alignment across delivered artifacts. In some embodiments, this is implemented in an indexer application instance and synchronizer module, such that indexer clusters similar inputs (based on embeddings) and synchronizer ensures consistent actions (e.g., pricing or publishing cadence) across those clusters

At the step 524, the machine learning module optimizes a utility function for one or more individual entities. Optimization drives the agent to act towards a defined goal, e.g., maximizing conversions or attention span per article. The utility function varies by system goal (e.g., engagement, revenue, trust). In an exemplary embodiment, optimization is done using a multi-objective RL controller with weighted rewards. An exemplary process includes assigning scores to user actions (click, share, dismiss, ignore) via pre-trained reward models; using TD3 (Twin Delayed DDPG) for reward optimization with less overestimation bias; and integrating multi-arm bandit layer to dynamically switch focus between utility objectives based on session characteristics. For example, in a morning session, the model prioritizes “speed to information”; in a weekend session, it switches to “content depth”. Optimization function is implemented at the CARL Application instance and Utility evaluator (logical evaluator within policy loop) that performs Custom utility functions (e.g., engagement*reach/cost) are optimized per deployment via feedback loops, tuning weights dynamically.

At step 526, the machine learning module self-adjusts the reinforcement learning algorithm, based on the environment at deployed location. In some embodiments, self-adjustment is driven by local environmental probes, which include one or more of a bandwidth_probe that detects upload/download speeds to select appropriate ML pipeline variant (e.g., quantized vs. full); a device_probe that detects CPU/GPU availability for model execution path; a content_drift_probe: that performs a KL divergence check between expected and actual user behavior vectors. When any of these probes breach thresholds, a self-adaptive controller triggers one or more of the following: policy recalibration (e.g., rebalancing action weights); lightweight local fine-tuning with recent usage window; and resource-aware model path selection (fallback to distilled models if needed). This makes the RL agent context-aware and environment-sensitive, allowing it to self-modulate actions at the appliance level.

The CARL application appliance performs the following steps Receiving input data is implemented at the Crawler Application instance, and scrapes data or ingests streaming inputs from enterprise sources—news, product info, analytics logs, etc. Vectorizing or transforming data is performed at the Vectorizer Application instance, and converts raw inputs (text, images, time-series) into fixed-length embeddings that are usable by the RL engine. Container-based deployment of intelligence is implemented at the CARL Deployment Management Software+Container deployment module+Installer module and ensures the system is self-contained and deployable in edge, on-premise, or hybrid setups. Configuration for optimization scenarios is implemented at the configurator module and defines deployment-specific parameters—e.g., pricing mode, priority channels, feedback weighting-without modifying the core system logic. Policy update or learning loop is implemented at the CARL Application instance (main RL loop) and continuously updates policies based on observations, decisions, rewards-driven by multi-armed bandits, Q-learning, or PPO architectures. Outputting processed data is implemented as the output stream via Container Engine 905A→downstream systems, and outputs enriched metadata, learned action values, updated vectors, or final recommendations back to enterprise stack or publication platforms. Edge or on-premise compatibility is implemented in the infrastructure layer (labeled Infrastructure or OS or GPU 907A) and indicates compatibility with non-cloud deployments for environments requiring privacy, security, or ultra-low latency.

The specific sequencing and composition of containers described herein is unconventional and provides technical advantages over the conventional systems. First, the modular deployment pattern for local intelligence allows the appliance to be deployed in environments with limited or no cloud access (e.g., client edge servers, regulated local zones). Instead of shipping monolithic models, each functional component is separately containerized for independent lifecycle management, allowing individual upgrades (e.g., vectorizer updates without redeploying RL, and resource-aware scheduling (e.g., stopping crawler if bandwidth constrained). Second, the system and methods provide functional chaining across containers. The crawler container ingests live digital content and logs structured activity. The vectorizer container semantically embeds this content with user behavior signatures. The RL container (CARL) uses these embeddings to take contextual pricing actions. Third, the systems and methods described herein provide an inter-container learning feedback loop. The vectorizer container dynamically re-weights its embedding output based on reward signals from the RL engine, e.g., a reverse loop where container 3 influences container 2, which is non-trivial in containerized ML pipelines. This dynamic feedback, e.g., when paired with orchestrated deployment control, provides an unconventional and superior architecture, especially in enterprise or edge deployment contexts.

In another embodiment of the invention, forecasting the resource utilization of the appliance using capacity planning models. In another embodiment of the invention, deploying the machine learning module as the third container inside the appliance performing the capacity planning models. In another embodiment of the invention, a management software module performing the step of deploying the machine learning module as a third container inside the appliance. In another embodiment of the invention, the appliance is deployed as an on-premise multi-container appliance. In another embodiment of the invention, the deployment of the on-premise multi-container appliance is orchestrated from the cloud. In another embodiment of the invention, deploying the machine learning module as a third container inside the appliance learning the environment at deployed location.

In an embodiment of the invention, the CARL as an appliance for deploying applications comprises a pre-configured software stack bundled with an operating system optimized for a specific purpose. The software appliance includes a virtual machine image or containerized application that can be deployed on various virtualization platforms or cloud environments. The appliance is designed for ease of installation and configuration, providing a turnkey solution for deploying complex software applications without the need for manual setup. The software appliance encapsulates all dependencies, libraries, and configuration settings required to run the application, ensuring consistent behavior across different environments. Users can deploy the software appliance by importing the virtual machine image or container and configuring minimal settings, thereby simplifying the deployment process and reducing overhead associated with traditional software installations.

In another embodiment of the invention, CARL as a hardware appliance comprises a dedicated physical device designed to perform specific functions or tasks, typically without the need for user installation or configuration. The hardware appliance includes integrated hardware components such as processors, memory, storage, and network interfaces, all optimized for the intended purpose. The appliance is pre-installed with firmware or software that enables it to operate autonomously upon power-up. Hardware appliances are commonly used for networking, security, storage, and other specialized applications where dedicated hardware resources provide performance advantages over software-based solutions. The design of a hardware appliance can vary from compact single-purpose devices to modular systems that can scale with additional components or configurations. By providing a self-contained and purpose-built solution, hardware appliances offer simplicity, reliability, and predictable performance in various application scenarios.

CARL Genome Template: The present invention relates to a customizable and adaptive framework for capturing detailed profiles of various entities within a dynamic ecosystem, referred to as the CARL (Complex Adaptive Reinforcement Learning) Genome Template. This template can be tailored for specific applications such as content pricing, IoT device management, and digital content valuation by selecting and modifying relevant fields.

The CARL Genome Template comprises several sections designed to capture comprehensive data on each entity. The General Information section includes fields such as Entity ID, Entity Type, Registration Date, and Location. The Identity and Reputation section captures details such as Name, Reputation Score derived from user feedback and industry benchmarks, Certifications, and Historical Performance Metrics.

The Content/Service Portfolio section details the types of content or services provided, formats, and the volume of content or services over a specified period. Engagement Metrics include User Engagement, Click-Through Rates (CTR), and Interaction Patterns, which provide insights into how users interact with the entity's offerings.

The Monetization History section records data on Revenue Generated, Pricing Structures, and Promotions and Discounts offered by the entity. The User Demographics section captures Audience Demographics, Behavioral Insights, and User Feedback and Ratings, helping to understand the characteristics and preferences of the audience attracted by the entity.

The Compliance and Ethics section ensures that entities adhere to Ethical Standards, Legal Compliance, and established Content Guidelines. The Adaptive Learning and Feedback section documents the Learning Algorithms Used, Model Update Frequency, and Feedback Loops, which are mechanisms for collecting and integrating user or entity feedback.

Custom fields specific to various use cases can be added to the template. For content pricing, fields such as Demand Behavior Analysis, Competitive Pricing Data, and Content Value Score are included. For IoT device management, fields like Device Type, Usage Patterns, Maintenance History, and Operational Efficiency Metrics are relevant. For digital content valuation, fields such as Content Quality Metrics, Market Reach, and Trend Analysis are considered.

The Integration and Aggregation section details the entity's role and participation in federated learning processes, the assigned Tier Level, and Aggregation Parameters used for model aggregation, such as weights and biases. This section ensures that the CARL central server can effectively leverage insights from the Publisher Genome attributes during federated averaging to compute global model parameters, giving higher weights to updates from high-tier publishers.

The CARL Genome Template is designed to be flexible and adaptable. Organizations can identify their specific use case, select the relevant fields, modify field definitions, add custom fields, and set parameters for adaptive learning, feedback loops, and model aggregation. This customization enables the creation of a robust and detailed profile framework tailored to specific needs, facilitating accurate and dynamic decision-making processes within the ecosystem.

The present invention also encompasses the use of the CARL Genome Template as an integral part of a software appliance, which is capable of automatically configuring and adapting various genome profiles for different use cases. This appliance leverages the customizable framework of the CARL Genome Template to dynamically generate and update genome profiles for entities such as content publishers, IoT devices, and digital content assets, thereby optimizing their operational and valuation processes.

Upon deployment, the CARL appliance utilizes the genome template to automatically identify the specific requirements of the use case. It extracts relevant fields from the template, such as Identity and Reputation, Content/Service Portfolio, Engagement Metrics, Monetization History, User Demographics, and Compliance and Ethics, among others. Based on predefined parameters and real-time data inputs, the appliance configures these fields to create a detailed and accurate genome profile tailored to the specific entity type.

The auto-configuration process involves selecting relevant data attributes, setting adaptive learning parameters, and defining feedback loops for continuous improvement. For instance, in the context of content pricing, the appliance may configure fields related to demand behavior, competitive pricing data, and content value scores. In IoT device management, it would focus on fields such as device type, usage patterns, and operational efficiency metrics.

The CARL appliance further incorporates adaptive reinforcement learning algorithms to continuously refine the genome profiles based on real-time interactions and feedback. This ensures that the profiles remain up-to-date and reflective of the current state and performance of the entities. The appliance also facilitates secure multi-party computation and differential privacy mechanisms during model aggregation, ensuring data privacy and integrity while synthesizing a global model.

By automating the configuration of genome profiles using the CARL Genome Template, the appliance significantly enhances the efficiency and accuracy of data-driven decision-making processes. It provides a scalable solution that can be easily adapted to various industries and applications, thereby maximizing the value and effectiveness of the deployed entities.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., communications software, server software, CARL appliance management module 116, interface or browser module 120, etc.). These systems may include any types of monitors and input devices (e.g., keyboard, mouse, voice recognition, etc.) to enter and/or view information.

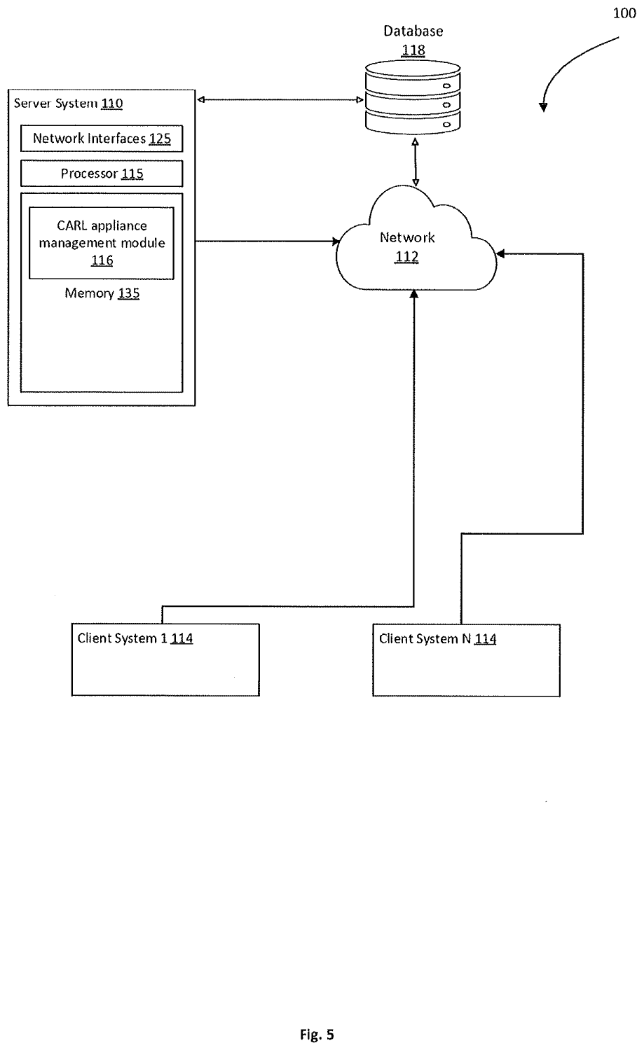

In some embodiments, referring to FIG. 5, platform 100 includes a server system 110 and a database 118. One or more client systems, e.g., client device 1 114 through client device N 114, sometimes referred to as client devices 114, are connected to the server system 110 via network 112. Client devices 114 of the exemplary computer-based system and platform 100 may include virtually any computing device capable of receiving and sending a message over a network (e.g., cloud network), such as network 112, to and from another computing device, such as server system 110, each other, and the like. In some embodiments, the system server 100 and/or client devices 114 may be personal computers, multiprocessor systems, microprocessor-based or programmable consumer electronics, network PCs, and the like. In some embodiments, the system server 100 and one or more client devices 114 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, the system server 100 and/or one or more clients 114 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, system server 110 and/or one or more client devices 114 may include may run one or more applications, such as Internet browsers, mobile applications, voice calls, video games, videoconferencing, and email, among others. In some embodiments, the system server 100 and/or one or more client devices 114 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, the system server 100 and/or client devices 114 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, the system server 100 and/or client devices 144 may periodically report status or send alerts over text or email. In some embodiments, the system server 100 and/or client devices 144 may contain a data recorder which is remotely downloadable by the user using network protocols such as FTP, SSH, or other file transfer mechanisms. In some embodiments, a member device may provide several levels of user interface, for example, advance user, standard user. In some embodiments, the system server 100 an/or client devices 144 and/or one or more clients 114 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, exemplary network 112 may provide network access, data transport and/or other services to any computing device coupled to it. In some embodiments, the exemplary network 112 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 112 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 112 may include and implement, as an alternative or in conjunction with one or more of the above, a WiMAX architecture defined by the WiMAX forum. In some embodiments and, optionally, in combination of any embodiment described above or below, the exemplary network 112 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 112 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 112 may also include mass storage, such as network attached storage (NAS), a storage area network (SAN), a content delivery network (CDN) or other forms of computer or machine readable media.

In some embodiments, the server system 110 may include a web server (or a series of servers) running a network operating system, examples of which may include but are not limited to Apache on Linux or Microsoft IIS (Internet Information Services). In some embodiments, the server system 110 may be used for and/or provide cloud and/or network computing. Although not shown in FIG. 1, some embodiments, the exemplary network 112 may have connections to external systems like email, SMS messaging, text messaging, ad content providers, etc.

In some embodiments, one or more of the exemplary network 112 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the server system 110 and client devices 114.

In some embodiments and, optionally, in combination of any embodiment described above or below, for example, one or more client devices 114 and the server system 110 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

FIG. 5 depicts a block diagram of the server system 110 in accordance with one or more embodiments of the present disclosure. In some embodiments, the server system 110 includes a computer-readable medium 135, such as a random-access memory (RAM) coupled to a processor 115 or FLASH memory. In some embodiments, the processor 115 may execute computer-executable program instructions stored in memory 135. In some embodiments, the processor 115 may include a microprocessor, an ASIC, and/or a state machine. In some embodiments, the processor 115 may include, or may be in communication with, media, for example computer-readable media, which stores instructions that, when executed by the processor 115, may cause the processor 115 to perform one or more steps described herein. System server 110 further includes the CARL appliance management module 116. In some embodiments, examples of computer-readable media may include, but are not limited to, an electronic, optical, magnetic, or other storage or transmission device capable of providing a processor, such as the processor of client device 114, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc. The server system 110 further includes a network interface 125 by any wired or wireless protocols known in the art.

In some embodiments, client devices 114 may also comprise a number of external or internal devices such as a mouse, a CD-ROM, DVD, a physical or virtual keyboard, a display, or other input or output devices. In some embodiments, examples of client devices 114 may be any type of processor-based platforms that are connected to a network 112 such as, without limitation, personal computers, digital assistants, personal digital assistants, smart phones, pagers, digital tablets, laptop computers, Internet appliances, and other processor-based devices. In some embodiments, client devices 114 may be specifically programmed with one or more application programs in accordance with one or more principles/methodologies detailed herein. In some embodiments, client devices 114 may operate on any operating system capable of supporting a browser or browser-enabled application, such as Microsoft™, Windows™, and/or Linux. In some embodiments, client devices 114 may include, for example, personal computers executing a browser application program such as Microsoft Corporation's Internet Explorer™, Apple Computer, Inc.'s Safari™, Mozilla Firefox, and/or Opera. In some embodiments, client devices 114 may communicate over the exemplary network 112 with each other and/or with other systems and/or devices coupled to the network. Client devices 114 may include a processor as well as memory, not shown. In some embodiments, the system server 110 and the one or more client devices 114 may be mobile devices. As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

In some embodiments, advertisement placement critically includes geographical information to maximize value. Accordingly, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For case, at times the above variations are not listed or are only partially listed; this is in no way meant to be a limitation.

In some embodiments, at least one database 118 of exemplary databases may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

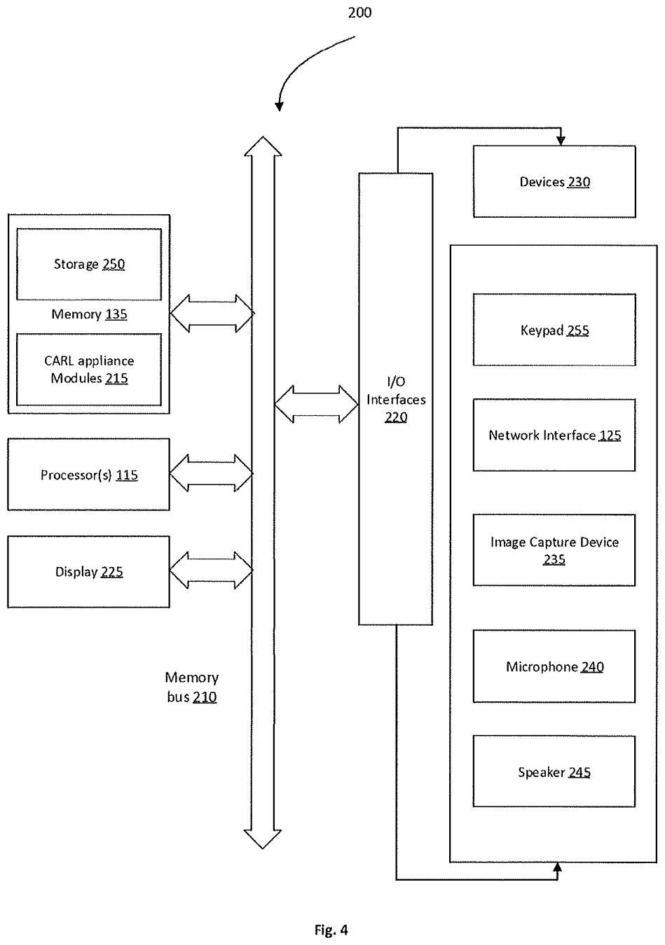

FIG. 4 is a further schematic view of the device 200, that can refer to system server 110 as discussed above. Each exemplary device 200 includes a processor 114, memory 135 and display 225. The memory 135, as discussed above, includes storage 250 and a CARL appliance management module 215. Device 200 further includes I/O interfaces 220 for connecting devices 230, keypad 225, network interface 125, image capture device 235, microphone 240 and speaker 245 to the processor 115, memory 135 and display 225 via a memory bus 210.

In some embodiments, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 910, platform as a service (PaaS), and/or software as a service (SaaS) using a web browser, mobile app, thin client, terminal emulator or other endpoint.

It is to be understood that the software of the present invention embodiments may be implemented in any desired computer language and could be developed by one of ordinary skill in the computer science based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for monitoring user activity and determining values for any items or objects in real-time.

A content item may be any type of digital or electronic item or object (e.g., document, web page, file, data object, etc.) containing any type, or a combination of any types, of data (e.g., text, multimedia, video, audio, image, streaming data, etc.). For example, a content item may include a news or other article, a web site or page, a paper, a document, program code or an application, an audio recording, a video, an image, a live or recorded podcast, streaming media, streaming media of a live event, a blog, a message, a chat, a conversation or other thread, any combination thereof, etc.

The classification may be performed by any conventional or other machine learning models (e.g., mathematical/statistical; classifiers; feed-forward, deep learning, recurrent, convolutional or other neural networks; unsupervised, supervised, or semi-supervised; etc.). The machine learning model may use unsupervised or supervised learning. Unsupervised machine learning uses data that has not been labeled, classified, or categorized. For example, an unsupervised machine learning model (e.g., neural network, etc.) may be trained with a training set of unlabeled data, where the neural network attempts to produce the provided data and uses an error from the output (e.g., difference between inputs and outputs) to adjust weight (and bias) values. A supervised machine learning model (e.g., neural network, etc.) may be trained with a training set including input and known output, where the neural network attempts to produce the provided output and uses an error from the output (e.g., difference between produced and known outputs) to adjust weight (and bias) values (e.g., via backpropagation or other training techniques).

The activity may include any online or other activities by any entity with respect to content items (e.g., clicks to access/initiate a transaction, cursor hover time, selection of content items, views of advertisements, etc.). The measurements or observations for the activity may include any desired information (e.g., quantity of clicks to access/initiate a transaction, amount of cursor hover time, quantity of selections of content items, quantity of views of advertisements, quantity of purchase or other transactions, etc.).

Multi-source valuation attributes (e.g., revenue, criticality, market indicators) compute both reward and placement optimization, creating a closed-loop feedback system. Embedding similarity is not just a matching layer, but part of the RL policy input, allowing contextual reinforcement to evolve over time. The RL agent is directly conditioned on valuation-driven utility, giving it the ability to differentiate between high-performing but low-value content and moderate-performing but strategically critical content, a use of multi-objective reward modeling. Based on such technical features, further technical benefits become available to users and operators of these systems and methods. Moreover, various practical applications of the disclosed technology are also described, which provide further practical benefits to users and operators that are also new and useful improvements in the art.

The disclosed subject matter introduces an advanced AI module or a set of AI modules by incorporating AI into the placement of advertisements brings benefits in terms of scalability, efficiency, and personalization. It allows for the placement of a large number of unique, tailored advertisements in real-time, matching the digital content. Furthermore, the AI module can learn from user engagement data to continuously improve the placement of the advertisements.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method comprising:
receiving a request to deploy a machine learning module as an appliance;
deploying and configuring a crawler service as a first container inside the appliance;
deploying and configuring a vectorizer service as a second container inside the appliance;
deploying the machine learning module as a third container inside the appliance, wherein the machine learning module comprises a reinforcement learning algorithm configured to:
determine a set of parameters based on internet activities of a user in a plurality of categories, wherein the set of parameters are content attributes associated with one or more user resonance;
learn the set of parameters to maximize the value function;
synchronize one or more specific action outputs using one or more synchronization constraints;
maintain coherence among similar entities, wherein the coherence is maintained by comparing a first multi-dimensional content feature vector of a first digital content to a second multi-dimensional content feature vector of a second digital content;
optimize a utility function for one or more individual entities; and
self-adjust the reinforcement learning algorithm, based on the environment at deployed location.

2. The method of claim 1, wherein the vectorizer service dynamically chooses, filters, and aligns embeddings based on multi-layer user-context resonance scoring.

3. The method of claim 1, wherein determine a set of parameters comprises determining one or more of the following parameters are learned from internet activity signals: rate of decay of user interest in a topic, entropy-based measurement of user consistency across content types; dwell time, scroll depth, and navigation patterns of users; logistic regression trained on user sharing vs. content rating behavior; and content diversity consumption.

4. The method of claim 1, further comprising periodically updating the parameters.

5. The method of claim 1, wherein learning the set of parameters to maximize the value function comprises choosing pricing actions to maximize engagement revenue over time.

6. The method of claim 1, wherein synchronizing one or more specific action outputs using one or more synchronization constraints comprises orchestrating multi-modal content actions.

7. The method of claim 1, wherein optimizing a utility function for one or more individual entities comprises using a multi-objective RL controller with weighted rewards.

8. The method of claim 1, wherein self-adjusting the reinforcement learning algorithm based on the environment at deployed location comprises detecting a breach in a threshold of one or more of bandwidth, CPU/GPU availability and KL divergence in user behavior.

9. The method of claim 8, wherein a self-adaptive controller triggers a policy change in the case of a threshold breach.

10. The method of claim 1, wherein the appliance is deployed as an on-premise multi-container appliance.

11. The method of claim 10, wherein the deployment of the on-premise multi-container appliance is orchestrated from the cloud.

12. The method of claim 11, further comprises the machine learning module as a third container inside the appliance learning the environment at deployed location.

13. The method of claim 1, further comprising, upon deploying and configuring the crawler service as the first container inside the appliance, verifying, by the processor, the deployment and configuration of the crawler service is successful.

14. The method of claim 1, further comprising, upon deploying and configuring the vectorizer service as the second container inside the appliance, verifying, by the processor, the deployment and configuration of the vectorizer service is successful.

15. A system comprising:
a processor configured to:
receive, via the processor, a request to deploy a machine learning module as an appliance;
deploy and configure, by the processor, a crawler service as a first container inside the appliance;
upon deploying and configuring, verify, by the processor, the deployment and configuration of the crawler service is successful;
deploy and configure, by the processor, a vectorizer service as a second container inside the appliance;
upon deploying and configuring, verify, by the processor, the deployment and configuration of the vectorizer service is successful; and
deploy, by the processor, the machine learning module as a third container inside the appliance, wherein the machine learning module comprises a reinforcement learning algorithm configured to:
determine, by the processor, a set of parameters based on internet activities of a user in the plurality of categories, wherein the set of parameters are the content attributes associated with one or more user resonance;
learn, by the processor, the set of parameters to maximize the value function;
synchronize, by the processor, one or more specific action outputs using one or more synchronization constraints;
maintain, by the processor, coherence among similar entities, wherein the coherence is maintained by comparing a first multi-dimensional content feature vector of a first digital content to a second multi-dimensional content feature vector of a second digital content;
optimize, by the processor, a utility function for one or more individual entities; and
self-adjust, by the processor, the reinforcement learning algorithm, based on the environment at deployed location.

16. The system of claim 15, wherein the vectorizer service is configured to dynamically choose, filter, and align embeddings based on multi-layer user-context resonance scoring.

17. The system of claim 15, wherein the machine learning module is configured to learn one or more of the following parameters from internet activity signals: rate of decay of user interest in a topic, entropy-based measurement of user consistency across content types; dwell time, scroll depth, and navigation patterns of users; logistic regression trained on user sharing vs. content rating behavior; and content diversity consumption.

18. The system of claim 15, further wherein the machine learning module is configured to periodically update the parameters.

19. The system of claim 15, wherein the machine module configured to learn the set of parameters to maximize the value function comprises choosing pricing actions to maximize engagement revenue over time.

20. The system of claim 15, wherein the machine module configured to synchronize one or more specific action outputs using one or more synchronization constraints comprises orchestrating multi-modal content actions.

21. The system of claim 15, wherein the machine module configured to optimize a utility function for one or more individual entities comprises using a multi-objective RL controller with weighted rewards.

22. The system of claim 15, wherein the machine module configured to self-adjust the reinforcement learning algorithm based on the environment at deployed location comprises detecting a breach in a threshold of one or more of bandwidth, CPU/GPU availability and KL divergence in user behavior.

23. The system of claim 22, wherein a self-adaptive controller triggers a policy change in the case of a threshold breach.

24. The system of claim 15, wherein the appliance is deployed as an on-premise multi-container appliance.

25. The system of claim 24, wherein the deployment of the on-premise multi-container appliance is orchestrated from the cloud.

26. The system of claim 24, further comprises the machine learning module as a third container inside the appliance learning the environment at deployed location.

27. One or more non-transitory computer readable media having instructions stored thereon, the instructions executable by a processor to cause the processor to:
receive, via the processor, a request to deploy a machine learning module as an appliance;
deploy and configure, by the processor, a crawler service as a first container inside the appliance;
upon deploying and configuring, verify, by the processor, the deployment and configuration of the crawler service is successful;
deploy and configure, by the processor, a vectorizer service as a second container inside the appliance;
upon deploying and configuring, verify, by the processor, the deployment and configuration of the vectorizer service is successful; and
deploy, by the processor, the machine learning module as a third container inside the appliance, wherein the machine learning module comprises a reinforcement learning algorithm configured to:
determine, by the processor, a set of parameters based on internet activities of a user in the plurality of categories, wherein the set of parameters are the content attributes associated with one or more user resonance;
learn, by the processor, the set of parameters to maximize the value function;
synchronize, by the processor, one or more specific action outputs using one or more synchronization constraints;
maintain, by the processor, coherence among similar entities, wherein the coherence is maintained by comparing a first multi-dimensional content feature vector of a first digital content to a second multi-dimensional content feature vector of a second digital content;
optimize, by the processor, a utility function for one or more individual entities; and
self-adjust, by the processor, the reinforcement learning algorithm, based on the environment at deployed location.

28. The non-transitory computer readable media of claim 27, wherein the vectorizer service is configured to dynamically choose, filter, and align embeddings based on multi-layer user-context resonance scoring.

29. The non-transitory computer readable media of claim 27, wherein the machine learning module is configured to learn one or more of the following parameters from internet activity signals: rate of decay of user interest in a topic, entropy-based measurement of user consistency across content types; dwell time, scroll depth, and navigation patterns of users; logistic regression trained on user sharing vs. content rating behavior; and content diversity consumption.

30. The non-transitory computer readable media of claim 27, further wherein the machine learning module is configured to periodically updating the parameters.

31. The non-transitory computer readable media of claim 27, wherein learning the set of parameters to maximize the value function comprises choosing pricing actions to maximize engagement revenue over time.

32. The non-transitory computer readable media of claim 27, wherein synchronizing one or more specific action outputs using one or more synchronization constraints comprises orchestrating multi-modal content actions.

33. The non-transitory computer readable media of claim 27, wherein optimizing a utility function for one or more individual entities comprises using a multi-objective RL controller with weighted rewards.

34. The non-transitory computer readable media of claim 27, wherein self-adjusting the reinforcement learning algorithm based on the environment at deployed location comprises detecting a breach in a threshold of one or more of bandwidth, CPU/GPU availability and KL divergence in user behavior.

35. The non-transitory computer readable media of claim 34, wherein a self-adaptive controller triggers a policy change in the case of a threshold breach.

36. The non-transitory computer readable media of claim 27, wherein the appliance is deployed as an on-premise multi-container appliance.

37. The non-transitory computer readable media of claim 36, wherein the deployment of the on-premise multi-container appliance is orchestrated from the cloud.

38. The non-transitory computer readable media of claim 36, further comprises the machine learning module as a third container inside the appliance learning the environment at deployed location.
